(19) United States
(12) Patent Application Publication
(10) Pub. No.: US 2006/0147364 A1
(43) Pub. Date: Jul. 6, 2006

(54) Process for synthesising porous crystalline aluminophosphate molecular sieves

(75) Inventors: Narayanan Venkatathri, Maharashtra (IN); Sooryakant Ganesh Hegde, Maharashtra (IN)

Correspondence Address: NIXON & VANDERHYE, PC, 901 NORTH GLEBE ROAD, 11TH FLOOR, ARLINGTON, VA, 22203, US

(73) Assignee: COUNCIL OF SCIENTIFIC AND INDUSTRIAL RESEARCH, New Delhi (IN)

(21) Appl. No.: 11/024,939

(22) Filed: Dec. 30, 2004

(51) Int. Cl. B01J 27/187; B01J 27/182; C01B 15/16; C01B 25/26

(52) U.S. Cl. 423/305; 502/208; 502/214; 423/306

(57) ABSTRACT

The present invention relates to an improved process for the preparation of porous crystalline aluminophosphate molecular sieves, which are useful as catalysts and adsorbents.

### FIELD OF THE INVENTION

The present invention relates to an improved process for the preparation of porous crystalline aluminophosphate molecular sieves. These molecular sieves are useful as catalysts and adsorbents.

### BACKGROUND OF THE INVENTION

Crystalline aluminosilicate zeolite type molecular sieves are well known in the art and are formed by corner sharing SiO₂ and AlO₂ tetrahedra and have pore openings of uniform dimensions, have a significant ion exchange capacity and are capable of reversibly desorbing an adsorbed phase which is dispersed throughout the internal voids of the crystal without displacing any atoms which make up the permanent crystal structure.

The most recently synthesized molecular sieves without silica are crystalline aluminophosphate compositions disclosed in U.S. Pat. No. 4,310,440. These materials are formed from AlO₂ and PO₂ tetrahedra and have electro neutral frameworks as in the case of silica polymorphs. The empirical chemical composition on anhydrous basis is mR(AlₓP_{y})O₂ wherein ‘R’ represents at least one organic templating agent present in the intracrystalline pore system, ‘m’ represents the moles of ‘R’ present per mole of (AlₓP_{y})O₂ and has a value of from 0.1 to 0.3 and x and y have value from 0.4 to 0.59 and 0.4 to 0.59 respectively.

Unlike the silica molecular sieve, silicalite, which is hydrophobic due to the absence of extra framework cation, aluminophosphate molecular sieves are moderately hydrophilic, apparently due to the difference in the electro negativities of aluminium and phosphorous The intracrystalline pore volumes and pore diameters are comparable to those known for zeolites and silica molecular sieves.

The prior art procedure for synthesis of AlPO-n disclosed in U.S. Pat. No. 4,310,440 involves reaction of aluminium isopropoxide or hydrated aluminium oxide with phosphoric acid and organic templating compounds such as Tripropyl amine or di-n-propyl amine by autoclaving the reaction mixture directly at an elevated temperature of 150° C. to 200° C. for 24 h to 168 h. The major disadvantages of the above prior art method for the synthesis of AlPO-n is lower crystallinity, higher time duration and costly templates.

While carrying out research on use of new templating agents for synthesis of aluminophosphate molecular sieves, we have observed that heating a reaction gel containing the necessary ingredients along with hexamethyleneimine in a controlled manner reduced crystalline time and gave more crystalline samples Based on above studies we have noted that the templating agent hexamethyleneimine crystallized number of aluminophosphates such as AlPO₄-5, AlPO₄-16, AlPO₄-22, AlPO₄-31, SAPO-35 and AlPO₄-L.

### OBJECTS OF THE INVENTION

The object of the invention is to provide an improved process for preparing aluminophosphate molecular sieves.

Another object is to provide a process for rapid preparation of aluminophosphate molecular sieves

Yet another object is to prepare more crystalline samples of aluminophosphate molecular sieves.

### SUMMARY OF THE INVENTION

The present invention provides an improved process for the preparation of a porous crystalline aluminophosphate molecular sieves characterized by the x-ray diffraction pattern as herein described and a chemical composition in terms of the mole ratio of oxides given by the formula mR: Al₂O₃:nP₂O₅ wherein R represents at least one organic templating agent present in the intracrystalline pore system; ‘m’ represents moles of ‘R’ present and has a value between 0.02 to 0.3, ‘n’ has a value of from 1.0 to 1.2, the process comprising
(a) mixing a source of hydrated aluminium oxide, a source of oxide of phosphorous and an organic templating agent (R) to form a reaction mixture,
(b) heating the reaction mixture obtained in step (a) under autogeneous conditions;
(c) cooling the reaction mixture obtained in step (b) rapidly to obtain crystalline material,
(d) separating the crystalline material obtained in step (c) followed by washing and drying the crystalline material;
(e) calcinating the washed and dried crystalline material obtained in step (d) to remove the organic templating agent to get porous crystalline aluminophosphate molecular sieves.

In one embodiment of the invention the source of aluminium oxide is pseudoboehmite and aluminium alkoxide, preferably aluminium isopropoxidee

In a preferred embodiment of the invention, the source of aluminium oxide is pseudoboehmite.

In another embodiment of the invention, the source of oxide of phosphorous is orthophosphoric acid.

In another embodiment of the invention the organic templating agent is selected from the group consisting of hexamethyleneimine, hexamethylene tetramine and di-n-propylamine.

In another embodiment of the invention, the reaction mixture is heated in step (b) at a temperature of about 200° C. for a period in the range of 4 h to 24 h.

In another embodiment of the invention, the crystalline material is separated by filtration.

In another embodiment of the invention, the crystals are washed with distilled water and then dried by heating at a temperature in the range of 25° C. to 150° C. at atmospheric pressure.

In another embodiment of the invention, the aluminophosphate molecular sieve is calcined at a temperature in the range of 300° C. to 1000° C. for a period in the range of 1 minute to 20 h.

In yet another embodiment of the invention, the calcination of the crystalline material is effected at a temperature of about 550° C. to remove the organic material occluded in the pore of the crystalline material

In another embodiment of the invention, the crystalline aluminophosphate molecular sieves formed is selected from the group consisting of AlPO₄-5, AlPO₄-16, AlPO₄-22, AlPO₄-31, AlPO₄-L, SAPO-35, SAPO-15 and VPI-5.

In another embodiment of the invention, a silicon source is added to the reaction mixture to obtain SAPO-35 and SAPO-15.

The present invention also provides a process for synthesising crystalline aluminophosphate molecular sieves selected from the group consisting of AlPO₄-5, AlPO₄-16, AlPO₄-22, AlPO₄-31, AlPO₄-L, SAPO-35, SAPO-15 and VPI-5, the process comprising
(a) forming a reaction gel by combining reactive aluminium and phosphorous sources followed by an organic template, and, if desired, a silicon source;
(b) heating the reaction gel under hydrothermal conditions followed by rapid cooling to obtain crystalline material;
(c) separating the crystalline material followed by washing and drying thereof,
(d) calcining the crystalline material to remove the templating agent and obtain the crystalline aluminophosphate molecular sieve.

In another embodiment of the invention, the source of silicon oxide is silica sol, fumed silica, tetraethylorthosilicate or mixtures thereof

In one embodiment of the invention the source of aluminium oxide is pseudoboehmite and aluminium alkoxide, preferably aluminium isopropoxidee

In a preferred embodiment of the invention, the source of aluminium oxide is pseudoboehmite.

In another embodiment of the invention, the source of oxide of phosphorous is orthophosphoric acid.

In another embodiment of the invention the organic templating agent is selected from the group consisting of hexamethyleneimine, hexamethylene tetramine and di-n-propylamine.

In another embodiment of the invention, step (b) is carried out in an autoclave and at a temperature of about 200° C. for different time duration

In another embodiment of the invention, the reaction gel is cooled by immersing in cold water.

In yet another embodiment of the invention, the crystalline material is separated by filtration.

In another embodiment of the invention, the crystals are washed with distilled water and then dried by heating at a temperature in the range of 25° C. to 150° C. at atmospheric pressure.

In yet another embodiment of the invention, the crystalline material is dried at a temperature of about 120° C.

In another embodiment of the invention, the aluminophosphate molecular sieve is calcined at a temperature in the range of 300° C. to 1000° C. for a period in the range of 1 minute to 20 h.

In yet another embodiment of the invention, the dried crystalline material is calcined in air at a temperature of about 550° C.

In yet another embodiment of the invention, the aluminophosphates molecular sieve in as-synthesized form has a composition in terms of molar oxide ratio on an anhydrous basis expressed by the formula mR: Al₂O₃:nP₂O₅:qSiO₂ wherein R represents at least one organic templating agent present in the intracrystalline pore system; ‘m’ represents the moles of ‘R’ present and has a value such that there are 0.02 to 0.3 moles of ‘R’ per mole of alumina, ‘n’ has a value of from 0.9 to 1.2 and ‘q’ has a value of from 0.0 to 1.0.

In another embodiment of the invention, the reaction mixture is essentially free of alkali metal cations and has a composition expressed in terms of mole ratio of oxides as follows aR: Al₂O₃:0.9-1.2P₂O₅:0.0-1.0SiO₂:bH₂O:bEG wherein R is an organic templating agent; ‘a’ has a value of from 0.20 to 2.0 and more preferably about 0.8 to 1.2; ‘b’ has a value between 10 to 45; EG—Ethylene Glycol

In another embodiment of the invention, aqueous or ethylene glycol reaction mixture is formed by combining reactive aluminium and phosphorous sources and thereafter combining the mixture with the organic template followed by a silicon source for SAPO-35 and SAPO-15 formation.

In another embodiment of the invention, the molecular sieve obtained is AlPO₄-5 having an X-ray diffraction pattern given in the table below:

| 2θ | d-spacing | Relative intensity |
|---|---|---|
| 7.68 | 11.5 | 49 |
| 13.16 | 6.72 | 8 |
| 15.16 | 5.84 | 18 |
| 20.08 | 4.42 | 47 |
| 21.02 | 4.22 | 54 |
| 22.68 | 3.92 | 100 |
| 26.32 | 3.38 | 39 |
| 29.18 | 3.06 | 22 |
| 30.44 | 2.93 | 27 |
| 35.00 | 2.56 | 23 |
| 37.74 | 2.38 | 23 |

In another embodiment of the invention, the molecular sieve obtained is AlPO₄-16 having an X-ray diffraction pattern given below:

| 2θ | d-spacing | Relative intensity |
|---|---|---|
| 11.28 | 7.83 | 62 |
| 15.48 | 5.72 | 2 |
| 17.26 | 5.13 | 2 |
| 18.66 | 4.75 | 50 |
| 21.86 | 4.06 | 100 |
| 22.90 | 3.875 | 9 |
| 26.50 | 3.357 | 27 |
| 27.60 | 3.23 | 2 |
| 27.94 | 3.19 | 2 |
| 29.96 | 3.08 | 12 |
| 29.72 | 3.00 | 28 |
| 32.72 | 2.735 | 4 |
| 34.60 | 2.585 | 5 |
| 37.36 | 2.374 | 8 |
| 39.56 | 2.276 | 2 |
| 44.16 | 2.049 | 2 |
| 45.46 | 1.877 | 6 |
| 52.34 | 1.746 | 3 |
| 54.74 | 1.675 | 3 |

In yet another embodiment of the invention, the molecular sieve obtained is AlPO₄-22 having an X-ray diffraction pattern given in the table below.

| 2θ | d-spacing | Relative intensity |
|---|---|---|
| 6.06 | 14.57 | 100 |
| 9.02 | 9.80 | 34 |
| 11.26 | 7.85 | 12 |
| 13.00 | 6.80 | 17 |
| 17.22 | 5.15 | 29 |
| 8.42 | 4.81 | 78 |
| 20.44 | 4.34 | 57 |
| 21.78 | 4.08 | 24 |
| 22.54 | 3.94 | 10 |
| 23.48 | 3.79 | 16 |
| 23.86 | 3.73 | 22 |
| 24.72 | 3.60 | 19 |
| 26.04 | 3.42 | 35 |
| 27.22 | 3.27 | 31 |
| 28.5 | 3.13 | 22 |
| 29.18 | 3.06 | 42 |
| 31.4 | 2.85 | 35 |
| 34.76 | 2.58 | 27 |
| 48.02 | 1.89 | 15 |
| 48.52 | 1.87 | 15 |

In yet another embodiment of the invention, the molecular sieve obtained is AlPO₄-22 having an X-ray diffraction pattern given in the table below.

| 2θ | d-spacing | Relative intensity |
|---|---|---|
| 7.48 | 11.82 | 22 |
| 14.98 | 5.91 | 18 |
| 19.84 | 4.47 | 37 |
| 20.44 | 4.34 | 25 |
| 21.10 | 4.21 | 19 |
| 21.80 | 4.07 | 100 |
| 22.48 | 3.95 | 45 |
| 26.04 | 3.42 | 23 |
| 29.14 | 3.06 | 10 |
| 30.16 | 2.96 | 21 |
| 31.16 | 2.87 | 13 |
| 34.70 | 2.58 | 16 |
| 35.78 | 2.51 | 26 |
| 37.82 | 2.38 | 9 |

In another embodiment of the invention, the molecular sieve obtained is AlPO₄-L having an X-ray diffraction pattern given in the table below.

| 2θ | d-spacing | Relative intensity |
|---|---|---|
| 6.4 | 13.80 | 100 |
| 12.6 | 7.02 | 8 |
| 18.6 | 4.77 | 12.5 |

In another embodiment of the invention, the molecular sieve obtained is SAPO-35 having an X-ray diffraction pattern given in the table below:

| 2θ | d-spacing | Relative intensity |
|---|---|---|
| 8.68 | 10.18 | 15 |
| 11.00 | 8.04 | 30 |
| 13.40 | 6.60 | 31 |
| 17.38 | 5.10 | 72 |
| 21.08 | 4.21 | 40 |
| 21.98 | 4.04 | 100 |
| 23.30 | 3.81 | 22 |
| 25.06 | 3.55 | 9 |
| 26.96 | 3.30 | 30 |
| 28.58 | 3.12 | 47 |
| 29.18 | 3.06 | 17 |
| 32.22 | 2.78 | 71 |
| 34.58 | 2.59 | 12 |
| 43.00 | 2.10 | 9 |

In another embodiment of the invention, the molecular sieve obtained is SAPO-15 having an X-ray diffraction pattern given in the table below;

| 2θ | d-spacing | Relative intensity |
|---|---|---|
| 11.98 | 7.38 | 45 |
| 13.48 | 7.56 | 77 |
| 15.16 | 5.84 | 100 |
| 19.3 | 4.60 | 50 |
| 21.04 | 4.22 | 17 |
| 21.50 | 4.13 | 34 |
| 24.06 | 3.70 | 33 |
| 25.6 | 3.48 | 12 |
| 26.98 | 3 30 | 15 |
| 29.78 | 3.00 | 57 |
| 30.50 | 2.93 | 50 |
| 31.80 | 2.81 | 44 |
| 32.28 | 2.77 | 60 |
| 34.46 | 2.61 | 61 |
| 35.94 | 2.50 | 15 |
| 36.90 | 2.43 | 14 |
| 37.82 | 2.38 | 13 |
| 38.94 | 2.31 | 38 |
| 39.90 | 2.26 | 11 |
| 40.78 | 2.21 | 12 |
| 42.24 | 2.14 | 15 |
| 43.28 | 2.09 | 16 |
| 44.02 | 2.06 | 10 |
| 46.16 | 1.96 | 23 |

In another embodiment of the invention, the molecular sieve obtained is VPI-5 having an X-ray diffraction pattern given in the table below

| 2θ | d-spacing | Relative intensity |
|---|---|---|
| 5.24 | 16.85 | 60 |
| 6.80 | 12.99 | 11 |
| 10.68 | 8.28 | 25 |
| 14.22 | 6.22 | 25 |
| 18.62 | 4.76 | 21 |
| 20.36 | 4.36 | 11 |
| 21.12 | 4.20 | 31 |
| 21.70 | 4.09 | 100 |
| 22.38 | 3.97 | 83 |
| 23.50 | 3.78 | 41 |
| 24.3 | 3.66 | 22 |
| 25.96 | 3.43 | 12 |
| 27.08 | 3.29 | 68 |
| 28.12 | 3.17 | 38 |
| 28.82 | 3.10 | 35 |
| 29.32 | 3.04 | 18 |
| 30.16 | 2.96 | 34 |
| 32.62 | 2.74 | 34 |
| 38.18 | 2.36 | 41 |
| 49.14 | 1.85 | 27 |

### DETAILED DESCRIPTION OF THE INVENTION

The present invention provides an improved process for the preparation of a porous crystalline aluminophosphate molecular sieves characterized by the x-ray diffraction pattern as herein described and a chemical composition in terms of the mole ratio of oxides given by the formula mR: Al₂O₃:nP₂O₅ wherein R represents at least one organic templating agent present in the intracrystalline pore system, ‘m’ represents moles of ‘R’ present and has a value between 0.02 to 0.3, ‘n’ has a value of from 1.0 to 1.2. The method of the invention comprises mixing a source of hydrated aluminium oxide and orthophosphoric acid and an organic template (R) which is an amine such as hexamethyleneimine. This mixture is heated under autogeneous conditions at 200° C. for 4 h to 24 h and the reaction mixture then cooled rapidly Crystalline material is then separated by filtration, washed and dried followed by calcination at 550° C. to remove organic material occluded in its pore to get porous crystalline aluminophosphate molecular sieves.

The source of aluminium oxide is preferably pseudoboehmite and source of oxide of phosphorous is orthophosphoric acid The organic template is hexamethyleneimine or hexamethylene tetramine or di-n-propylamine. The aluminophosphate molecular sieves obtained are AlPO₄-5, AlPO₄-16, AlPO₄-22, AlPO₄-31, AlPO₄-L, SAPO-35, SAPO-15 and VPI-5. In the process of the invention, a reaction gel formed by combining reactive aluminium and phosphorous sources followed by the organic template and the silicon source for SAPO-35 and SAPO-15 was subjected to heating under hydrothermal conditions in an autoclave at 200° C. for various time duration. This was then cooled rapidly by immersing in cold water. The contents were filtered to separate the crystalline solid which is subsequently washed thoroughly and dried at 120° C. and finally calcined in air at 550° C. The AlPO synthesized by the above process is made up of well-crystalline, small and more uniform particles. The aluminophosphates in the as-synthesized form has a composition in terms of molar oxide ratio on an anhydrous basis expressed by the formula mR: Al₂O₃:nP₂O₅:qSiO₂ where R represents at least one organic templating agent present in the intracrystalline pore system; ‘m’ represents the moles of ‘R’ present and has a value such that there are 0.02 to 0.3 moles of ‘R’ per mole of alumina, ‘n’ has a value of from 0.9 to 1.2 and ‘q’ has a value of from 0.0 to 1.0.

In synthesizing the aluminophosphate composition of the present invention, it is preferred that the reaction mixture be essentially free of alkali metal cations, and accordingly the preferred reaction mixture composition expressed in terms of mole ratio of oxides is as follows aR: Al₂O₃:0.9-1.2P₂O₅:0.0-1.0SiO₂:bH₂O:bEG where in R is an organic templating agent; ‘a’ has preferably a value of from 0.20 to 2.0 and more preferably about 0.8 to 1.2; ‘b’ has a value between 10 to 45, EG—Ethylene Glycol. In the synthesis of the invention an aqueous or ethylene glycol reaction mixture is formed by combining the reactive aluminium and phosphorous sources and thereafter combing the mixture with the template followed by silicon source in SAPO-35 and SAPO-15.

More specifically the synthesis method comprises:
(a) preparing an aqueous reaction mixture containing pseudoboehmite and phosphoric acid and thereafter combining the resulting mixture with an organic templating agent
(b) Heating the reaction mixture to a temperature of 200° C. for various time durations.
(c) Recovering the crystalline aluminophosphate by known methods of filtration and washing.

The crystallization is conducted under hydrothermal conditions in an autoclave at autogenous pressure without stirring. Following the crystallization of the aluminophosphate material, the reaction mixture containing the same is filtered and the recovered crystals are washed for example with distilled water and then dried such as by heating at from 25° C. to 150° C. at atmospheric pressure.

The aluminophosphate synthesized by the present method is subjected to thermal treatment to remove the organic templating agent. Thermal treatment is generally performed by heating at a temperature of 300° C. to 1000° C. for at least 1 minute and generally no longer than 20 h. The thermally treated product is particularly useful in the catalysis of certain hydrocarbon conversion reactions.

The improved process of this invention will now be illustrated by examples, which are not to be constructed as limiting the invention in any manner.

### EXAMPLE 1

### Synthesis of AlPO₄-5 using hexamethyleneimine Template in aq. Medium

7.16 g of catapal B (74.2% Al₂O₃, Vista Chemicals, USA) was mixed with 20 ml of water. The mixture was stirred well. 11.5 g of orthophosphoric acid (85%, s.d.fine, India) is added drop wise to the mixture and stirred well. A white thick paste was formed. This paste was aged for overnight. 5.82 g of hexamethyleneimine (98%, Aldrich, U.S.A) along with 20 ml of distilled water was mixed well and the active gel (Al2O₃:P₂O₅:1.16HEM:45H₂O) was charged into a Teflon lined autoclave. The gel was crystallized for 4 h at 473K. The product is cooled, washed several times with distilled water and dried at 383K and subjected to physicochemical characterization. AlPO₄-5 aluminophosphate synthesized by the process of the invention possesses a crystalline structure, the X-ray powder diffraction pattern of the as-synthesized form showing the characteristic peaks listed in Table 1.

TABLE 1
X-ray diffraction pattern of the Aluminophosphate (AlPO₄-5)

| 2θ | d-spacing | Relative intensity |
|---|---|---|
| 7.68 | 11.5 | 49 |
| 13.16 | 6.72 | 8 |
| 15.16 | 5.84 | 18 |
| 20.08 | 4.42 | 47 |
| 21.02 | 4.22 | 54 |
| 22.68 | 3.92 | 100 |
| 26.32 | 3.38 | 39 |
| 29.18 | 3.06 | 22 |
| 30.44 | 2.93 | 27 |
| 35.00 | 2.56 | 23 |
| 37.74 | 2.38 | 23 |

### EXAMPLE 2

### Synthesis of AlPO₄-5 using hexamethyleneimine Template in Non-Aqueous Medium

6.05 g of finely powdered aluminium isopropoxide was mixed with 45.50 g of ethyleneglycol (EG) 7.27 g of hexamethyleneimine (HEM) was added dropwise to mixture and made into a homogeneous entity 6.024 g of orthophosphoric was added to the gel. The active gel (Al₂O₃:1.8P₂O₅:4.5HEM:45EG) was charged into a Teflon lined steel autoclave. Crystallization was carried out at 473K for 15 days. Resulting product was washed well with distilled water and dried at 383K and subjected to physicochemical characterization.

### EXAMPLE 3

### Synthesis of AlPO₄-16 from hexamethyleneimine Template

10.86 g of aluminium isopropoxide (98%, Aldrich, U.S.A) is mixed with 20 ml of distilled water. 3.387 g of Hexamethyleneimine was added to the above mixture. The mixture was stirred well A mixture of solution was formed To this solution 5.75 g of orthophosphoric acid was added. The active gel (Al₂O₃:P₂O₅:1.16HEM:45H₂O) was charged into the Teflon lined autoclave and aloud to crystallize for 2 days The product was cooled and washed, dried at 283K and subjected to physicochemical characterization. The AlPO₄-16 aluminophosphate synthesized by the process of the present invention possesses a crystalline structure, the X-ray powder diffraction pattern of the as-synthesized form showing the characteristic peaks listed in Table 2.

TABLE 2
X-ray diffraction pattern of the aluminophosphate (AlPO₄-16)

| 2θ | d-spacing | Relative intensity |
|---|---|---|
| 11.28 | 7.83 | 62 |
| 15.48 | 5.72 | 2 |
| 17.26 | 5.13 | 2 |
| 18.66 | 4.75 | 50 |
| 21.86 | 4.06 | 100 |
| 22.90 | 3.875 | 9 |
| 26.50 | 3.357 | 27 |
| 27.60 | 3.23 | 2 |
| 27.94 | 3.19 | 2 |
| 29.96 | 3.08 | 12 |
| 29.72 | 3.00 | 28 |
| 32.72 | 2.735 | 4 |
| 34.60 | 2.585 | 5 |
| 37.36 | 2.374 | 8 |
| 39.56 | 2.276 | 2 |
| 44.16 | 2.049 | 2 |
| 45.46 | 1.877 | 6 |
| 52.34 | 1.746 | 3 |
| 54.74 | 1.675 | 3 |

### EXAMPLE 4

### Synthesis of AlPO₄-22 by Adding Excess Template

3.58 g of pseudoboehmite is mixed well with 10 ml of distilled water. 5.75 g of orthophosphoric acid was added drop wise to the mixture. The resulting white thick paste was aged for overnight. 3.387 g of hexamethyleneimine along with 10 ml of distilled water were added to the paste to make clear gel. The resulting active gel (Al₂O₃:P₂O₅:1.35HEM:45H₂O) was charged into a Teflon lined steel autoclave. Reaction mixture was crystallized for 48 h. Crystallized products washed with distilled water for several times and dried at ambient temperature and subject to physicochemical characterization. AlPO₄-22 aluminophosphate synthesized by this process possesses a crystalline structure, X-ray powder diffraction pattern of as-synthesized form showing the characteristic peaks listed in Table 3.

TABLE 3
X-ray diffraction pattern of the aluminophosphate (AlPO₄-22)

| 2θ | d-spacing | Relative intensity |
|---|---|---|
| 6.06 | 14.57 | 100 |
| 9.02 | 9.80 | 34 |
| 11.26 | 7.85 | 12 |
| 13.00 | 6.80 | 17 |
| 17.22 | 5.15 | 29 |
| 8.42 | 4.81 | 78 |
| 20.44 | 4.34 | 57 |
| 21.78 | 4.08 | 24 |
| 22.54 | 3.94 | 10 |
| 23.48 | 3.79 | 16 |
| 23.86 | 3.73 | 22 |
| 24.72 | 3.60 | 19 |
| 26.04 | 3.42 | 35 |
| 27.22 | 3.27 | 31 |
| 28.5 | 3.13 | 22 |
| 29.18 | 3.06 | 42 |
| 31.4 | 2.85 | 35 |
| 34.76 | 2.58 | 27 |
| 48.02 | 1.89 | 15 |
| 48.52 | 1.87 | 15 |

### EXAMPLE 5

### Synthesis of AlPO₄-22 by Adding Excess Template

3.58 g of pseudoboehmite was mixed well with 10 ml of distilled water. 5.75 g of orthophosphoric acid was added drop wise to the above mixture. A thick white paste is formed. The paste is aged for overnight at room temperature. 3.763 g of hexamethyleneimine along with 10 ml of distilled water was thoroughly mixed with the white paste. The resulting active gel (Al₂O₃:P₂O₅:1.5HEM:45H2O) was charged into a Teflon lined steel autoclave. Crystallization was carried out for 2 days at 453K. The product was washed well and dried at 383K and subjected to physicochemical characterization.

### EXAMPLE 6

### Synthesis of AlPO₄-22 by Adding Less Water to a Non-Aqueous Gel System

6.05 g of Aluminium isopropoxide was mixed well with 45.50 g of ethylene glycol. 5.224 g of water is mixed with the above solution. Then 7.27 g of hexamethyleneimine was added to the former mixture. Finally 6.024 g of orthophosphoric acid was added to make an active gel (Al₂O₃:1.8P₂O₅:4.5HEM:20H₂O:45EG). Gel was charged into a Teflon lined steel autoclave. Crystallization was carried out for 15 days at 453K. Product was washed well with distilled water and dried at 383K and subjected to physicochemical characterization.

### EXAMPLE 7

### Synthesis of AlPO₄-22 by Addition of Water to the Non-Aqueous Gel System

6.05 g of aluminium was mixed with 45.50 g of ethyleneglycol 13.06 g of water was added to the above mixture. Further 7.27 g of hexamethyleneimine was added to the above solution. Then 6.024 g of orthophosphoric acid was added to the former gel. The final active gel (Al₂O₃:1.8P₂O₅:4.5HEM:50H₂O:45EG) charged into a Teflon lined steel autoclave. Crystallization carried out at 453K for 15 days The product removed, washed and dried at 383K and subjected to physicochemical characterization.

### EXAMPLE 8

### Synthesis of AlPO₄-22 by Addition of sodium hydroxide

6.05 g of finely powdered aluminium isopropoxide was mixed well with 45.50 g of ethylene glycol. 0.526 g of fumed silica was added to the above mixture. 7.27 g of hexamethyleneimine was added to form clear gel. 6.024 orthophosphoric acid along with 0.351 g of sodium hydroxide were added. The final active gel (Al₂O₃:1.8P₂O₅:0.25Na₂O:4.5HEM:45EG) was charged into a Teflon lined steel autoclave. Crystallization was carried out at 453K for 15 days. The product was washed well with distilled water, and dried at 383K and subjected to physicochemical characterization.

### EXAMPLE 9

### Synthesis of AlPO₄-22 by Addition of dipropylamine

6.05 g of finely powdered aluminium isopropoxide was mixed well with 45.50 g of ethylene glycol 7.27 g of hexamethyleneimine was added slowly to the above mixture and stirred well. 6.024 g of orthophosphoric acid was added slowly to the above gel. The final gel (Al₂O₃:1.8P₂O₅:4.5HEM:4.5DPA:45EG) was prepared by adding 7.417 g di-n-propylamine (DPA). The active gel charged into a Teflon lined steel autoclave. Crystallization carried out at 453K for 15 days. The product was washed well with distilled water, and dried at 383K and subjected to physicochemical characterization.

### EXAMPLE 10

### Synthesis of Al₄PO₄-22 by Varying the Water Content

3.58 g of pseudoboehmite was mixed well with 10 ml of distilled water. 5.75 g of orthophosphoric acid was added drop wise to the above mixture. The mixture is stirred well. A thick white paste was formed. The paste is aged for overnight at room temperature Hexamethyleneimine (2.91 g) along with 23.33 g of distilled water was mixed with the white paste. The final active gel (Al₂O₃:P₂O₅:1.16HEM:75H₂O) was charged into a Teflon lined steel autoclave. Crystallization was carried out at 453K for 24 h. Product was washed well with distilled water and dried at 383K and subjected to physicochemical characterization.

### EXAMPLE 11

### Synthesis of AlPO₄-22 by Varying the Template Concentration

3.58 g of pseudoboehmite is mixed well with 10 g of distilled water. 5.75 g of orthophosphoric acid was added drop wise and the mixture is stirred well A white thick paste was formed which was aged for overnight at room temperature 2.509 g of 5 hexamethyleneimine along with 10 ml of distilled water was mixed with the paste. The final active gel (Al₂O₃:P₂O₅:HEM:45H₂O) was charged into a Teflon lined steel autoclave. Crystallization was carried out for 3 days at 453K. The product was washed well with distilled water and dried at 383K and subjected to physicochemical characterization.

### EXAMPLE 12

### Synthesis of AlPO₄-31 Using an Efficient Template hexamethyleneimine

6.05 g of aluminium isopropoxide was mixed well with 45.50 g of ethylene glycol (99%, s.d.fine, India). To this mixture 7.27 g of hexamethyleneimine was added. The mixture was stirred well to make homogeneous. 6.024 g of orthophosphoric acid was added dropwise to the above gel. The active gel was aged for 8 h under stirring. Final gel charged into a steel autoclave lined with Teflon. Crystallization was carried out at 473K for 15 days. Product was washed, dried and subjected to physicochemical characterization AlPO₄-31 aluminophosphate synthesized by this process possesses a crystalline structure, X-ray powder diffraction pattern of as-synthesized form showing the characteristic peaks listed in Table 4.

TABLE 4
X-ray diffraction pattern of the aluminophosphate (AlPO₄-31)

| 2θ | d-spacing | Relative intensity |
|---|---|---|
| 7.48 | 11.82 | 22 |
| 14.98 | 5.91 | 18 |
| 19.84 | 4.47 | 37 |
| 20.44 | 4.34 | 25 |
| 21.10 | 4.21 | 19 |
| 21.80 | 4.07 | 100 |
| 22.48 | 3.95 | 45 |
| 26.04 | 3.42 | 23 |
| 29.14 | 3.06 | 10 |
| 30.16 | 2.96 | 21 |
| 31.16 | 2.87 | 13 |
| 34.70 | 2.58 | 16 |
| 35.78 | 2.51 | 26 |
| 37.82 | 2.38 | 9 |

### EXAMPLE 13

### Synthesis of aluminophosphate, AlPO₄-L Using hexamethyleneimine Template

3.58 g of pseudoboehmite mixed well with 10 ml of distilled water. 5.75 g of orthophosphoric acid was added slowly to the mixture. A thick white paste is formed. This paste was aged overnight. 5.82 g of hexamethyleneimine along with 10 ml of distilled water is mixed with the paste. The mixture stirred well to form an active gel (Al₂O₃:P₂O₅:2.32HEM:45H₂O). This gel charged into a Teflon lined steel autoclave. Crystallization was carried out at 453K for 8 days The product was washed well with distilled water and dried at 383K and subjected to physicochemical characterization.

The AlPO₄-L aluminophosphate synthesized by the process of the present invention possesses a crystalline structure, the X-ray powder diffraction pattern of the as-synthesized form showing the characteristic peaks listed in Table 5.

TABLE 5
X-ray diffraction pattern of aluminophosphate, AlPO₄-L

| 2θ | d-spacing | Relative intensity |
|---|---|---|
| 6.4 | 13.80 | 100 |
| 12.6 | 7.02 | 8 |
| 18.6 | 4.77 | 12.5 |

### EXAMPLE 14

### Synthesis of SAPO-35 Using hexamethyleneimine

6.05 g of aluminium isopropoxide was mixed well with 45.50 g of ethylene glycol. 0.526 g fumed silica (>99%, Aldrich, India) was added to the mixture. The mixture was made homogeneous. 7.27 g of hexamethyleneimine was added followed by dropwise addition of 6.024 g of orthophosphoric acid. The homogeneous gel (Al₂O₃:1.8P₂O₅:0.3SiO₂:4.5HEM:45EG) was thoroughly mixed for 8 h and charged into a Teflon lined steel autoclave. Crystallization was carried out at 473K for 15 days. Product was washed several times with water and dried at 383 k and subjected to physicochemical characterization.

The SAO-35 silicoaluminophosphate synthesized by the process of the present invention possesses a crystalline structure, the X-ray powder diffraction pattern of the as-synthesized form showing the characteristic peaks listed in Table 6.

TABLE 6
X-ray diffraction pattern of the
silicoaluminophospahte (SAPO-35)

| 2θ | d-spacing | Relative intensity |
|---|---|---|
| 8.68 | 10.18 | 15 |
| 11.00 | 8.04 | 30 |
| 13.40 | 6.60 | 31 |
| 17.38 | 5.10 | 72 |
| 21.08 | 4.21 | 40 |
| 21.98 | 4.04 | 100 |
| 23.30 | 3.81 | 22 |
| 25.06 | 3.55 | 9 |
| 26.96 | 3.30 | 30 |
| 28.58 | 3.12 | 47 |
| 29.18 | 3.06 | 17 |
| 32.22 | 2.78 | 71 |
| 34.58 | 2.59 | 12 |
| 43.00 | 2.10 | 9 |

### EXAMPLE 15

### Synthesis of SAPO-15 Using hexamethylenetetramine

3.58 g of catapal B was mixed well with 10 ml of distilled water. 5.75 g of orthophosphoric acid was added slowly drop by drop to the mixture The resulting thick white paste was aged over night at room temperature. 4.28 g of hexamethylenetetramine (HMT) along with 10 ml of distilled water along with fumed silica was mixed well with the white paste. The final active gel (Al₂O₃:P₂O₅:0.3SiO₂:1.16HMT:45H₂O) Was charged into a steel autoclave lined with Teflon. Crystallization was carried out at 453K for 2 days. Product was washed well with distilled water and dried at 483K and subjected to physicochemical characterization.

The SAPO-15 aluminophosphate synthesized by the process of the present invention possesses a crystalline structure, the X-ray powder diffraction pattern of the as-synthesized form showing the characteristic peaks listed in Table 7.

TABLE 7
X-ray diffraction pattern of the aluminophosphate (SAPO-15)

| 2θ | d-spacing | Relative intensity |
|---|---|---|
| 11.98 | 7.38 | 45 |
| 13.48 | 7.56 | 77 |
| 15.16 | 5.84 | 100 |
| 19.3 | 4.60 | 50 |
| 21.04 | 4.22 | 17 |
| 21.50 | 4.13 | 34 |
| 24.06 | 3.70 | 33 |
| 25.6 | 3.48 | 12 |
| 26.98 | 3.30 | 15 |
| 29.78 | 3.00 | 57 |
| 30.50 | 2.93 | 50 |
| 31.80 | 2.81 | 44 |
| 32.28 | 2.77 | 60 |
| 34.46 | 2.61 | 61 |
| 35.94 | 2.50 | 15 |
| 36.90 | 2.43 | 14 |
| 37.82 | 2.38 | 13 |
| 38.94 | 2.31 | 38 |
| 39.90 | 2.26 | 11 |
| 40.78 | 2.21 | 12 |
| 42.24 | 2.14 | 15 |
| 43.28 | 2.09 | 16 |
| 44.02 | 2.06 | 10 |
| 46.16 | 1.96 | 23 |

### EXAMPLE 16

### Synthesis of VPI-5 at Shorter Duration

3.58 g of pseudoboehmite was mixed well with 10 ml of distilled water. 5.75 g of orthophosphoric acid was added drop wise to the above mixture. The resulting thick white paste was aged overnight at room temperature. 2.969 g of di-n-pripylamine along with 10 ml of distilled water is mixed thoroughly with the white paste. The final active gel (Al₂O₃:P₂O₅:1.16DPA:45H₂O) charged into a steel autoclave lined with Teflon. Crystallization was carried out for 2 h at 415K. Product was washed several times with distilled water and dried at 383K and subjected to physicochemical characterization.

The VPI-5 aluminophosphate synthesized by the process of the present invention possesses a crystalline structure, the X-ray powder diffraction pattern of the as-synthesized form showing the characteristics peaks listed in Table 8.

TABLE 8
X-ray diffraction pattern of the aluminophosphate (VPI-5)

| 2θ | d-spacing | Relative intensity |
|---|---|---|
| 5.24 | 16.85 | 60 |
| 6.80 | 12.99 | 11 |
| 10.68 | 8.28 | 25 |
| 14.22 | 6.22 | 25 |
| 18.62 | 4.76 | 21 |
| 20.36 | 4.36 | 11 |
| 21.12 | 4.20 | 31 |
| 21.70 | 4.09 | 100 |
| 22.38 | 3.97 | 83 |
| 23.50 | 3.78 | 41 |
| 24.3 | 3.66 | 22 |
| 25.96 | 3.43 | 12 |
| 27.08 | 3.29 | 68 |
| 28.12 | 3.17 | 38 |
| 28.82 | 3.10 | 35 |
| 29.32 | 3.04 | 18 |
| 30.16 | 2.96 | 34 |
| 32.62 | 2.74 | 34 |
| 38.18 | 2.36 | 41 |
| 49.14 | 1.85 | 27 |

We claim:

1. A process for the preparation of a porous crystalline aluminophosphate molecular sieves characterized by the x-ray diffraction pattern as herein described and a chemical composition in terms of the mole ratio of oxides given by the formula mR: Al₂O₃:nP₂O₅ wherein R represents at least one organic templating agent present in the intracrystalline pore system, ‘m’ represents moles of ‘R’ present and has a value between 0.02 to 0.3, ‘n’ has a value of from 1.0 to 1.2, the process comprising
(a) mixing a source of hydrated aluminium oxide, a source of oxide of phosphorous and an organic templating agent (R) to form a reaction mixture:
(b) heating the reaction mixture obtained in step (a) under autogeneous conditions followed by rapid cooling to obtain a crystalline material:
(c) separating the crystalline material obtained in step (b) followed by washing and drying the crystalline material;
(d) calcinating the washed and dried crystalline material obtained in step (e) to remove the organic templating agent and obtain a crystalline aluminophosphate molecular sieve.

2. A process as claimed in claim 1 wherein the source of aluminium oxide is selected from pseudoboehmite and aluminium alkoxide.

3. A process as claimed in claim 2 wherein the aluminium alkoxide is aluminium isopropoxide.

4. A process as claimed in claim 1 wherein the source of aluminium oxide is pseudoboehmite.

5. A process as claimed in claim 1 wherein the source of oxide of phosphorous is orthophosphoric acid.

6. A process as claimed in claim 1 wherein organic templating agent is selected from the group consisting of hexamethyleneimine, hexamethylene tetramine and di-n-propylamine.

7. A process as claimed in claim 1 wherein the reaction mixture is heated in step (b) at a temperature of about 200° C. for a period in the range of 4 h to 24 h

8. A process as claimed in claim 1 wherein crystalline material is separated by filtration

9. A process as claimed in claim 1 wherein the crystals are washed with distilled water and dried by heating at a temperature in the range of 25° C. to 150° C. at atmospheric pressure.

10. A process as claimed in claim 1 wherein aluminophosphate molecular sieve is calcined at a temperature in the range of 300-1000° C. for a period in the range of 1 minute to 20 h.

11. A process as claimed in claim 1 wherein the calcination of the crystalline material is effected at a temperature of about 550° C. to remove the organic material occluded in the pore of the crystalline material,

12. A process as claimed in claim 1 wherein the crystalline aluminophosphate molecular sieves formed is selected from the group consisting of AlPO₄-5, AlPO₄-16, AlPO₄-22, AlPO₄-31, AlPO₄-L, SAPO-35, SAPO-15 and VPI-5.

13. A process as claimed in claim 1 wherein a silicon oxide source is added to the reaction mixture to obtain SAPO-35 and SAPO-15.

14. A process as claimed in claim 13 wherein the source of silicon oxide is selected from the group consisting of silica sol, fumed silica, tetraethylorthosilicate and mixtures thereof.

15. A process for synthesising crystalline aluminophosphate molecular sieves selected from the group consisting of AlPO₄-5, AlPO₄-16, AlP₄-22, AlPO₄-31, AlPO₄-L, SAPO-35, SAPO-15 and VPI-5, the process comprising:
(a) forming a reaction gel by combining reactive aluminium and phosphorous sources followed by an organic template, and, if desired, a silicon source;
(b) heating the reaction gel under hydrothermal conditions followed by rapid cooling to obtain crystalline material;
(c) separating the crystalline material followed by washing and drying thereof;
(d) calcining the crystalline material to remove the templating agent and obtain the crystalline aluminophosphate molecular sieve

16. A process as claimed in claim 15 wherein the source of silicon is selected from the group consisting of silica sol, fumed silica, tetraethylorthosilicate and mixtures thereof.

17. A process as claimed in claim 15 wherein the source of aluminium oxide is selected from pseudoboehmite and aluminium alkoxide.

18. A process as claimed in claim 17 wherein the aluminium alkoxide is isopropoxide.

19. A process as claimed in claim 15 wherein the aluminium oxide source is pseudoboehmite.

20. A process as claimed in claim 15 wherein the source of oxide of phosphorous is orthophosphoric acid.

21. A process as claimed in claim 15 wherein organic templating agent is selected from the group consisting of hexamethyleneimine, hexamethylene tetramine and di-n-propylamine.

22. A process as claimed in claim 15 wherein step (b) is carried out in an autoclave and at a temperature of about 200° C. for different time duration.

23. A process as claimed in claim 15 wherein the reaction gel is cooled by immersing in cold water.

24. A process as claimed in claim 15 wherein the crystalline material is separated by filtration.

25. A process as claimed in claim 15 wherein the crystals are washed with distilled water and dried by heating at a temperature in the range of 25-150° C. at atmospheric pressure.

26. A process as claimed in claim 15 wherein the crystalline material is dried at a temperature of about 120° C.

27. A process as claimed in claim 15 wherein aluminophosphate molecular sieve is calcined at a temperature in the range of 300-1000° C. for a period in the range of 1 minute to 20 h.

28. A process as claimed in claim 15 wherein the dried crystalline material is calcined in air at a temperature of about 550° C.

29. A process as claimed in claim 15 wherein the molecular sieve is crystalline and is formed as small and uniform particles.

30. A process as claimed in claim 15 wherein the aluminophosphates molecular sieve as-synthesized form has a composition in terms of molar oxide ratio on anhydrous basis expressed by formula mR:Al₂O₃:nP₂O₅:qSiO₂ wherein R represents at least one organic templating agent present in the intracrystalline pore system; ‘m’ represents the moles of ‘R’ present and has a value such that there are 0.02 to 0.3 moles of ‘R’ per mole of alumina, ‘n’ has a value of from 0.9 to 1.2 and ‘q’ has a value of from 0.0 to 1.0

31. A process as claimed in claim 15 wherein the reaction mixture is essentially free of alkali metal cations and has a composition expressed in terms of mole ratio of oxides as follows aR Al₂O₃:0.9-1.2P₂O₅:0.0-1.0SiO₂:bH₂O:bEG wherein R is an organic templating agent, ‘a’ has a value of from 0.20 to 2.0; ‘b’ has a value between 10 to 45, EG—Ethylene Glycol.

32. A process as claimed in claim 31 wherein ‘a’ has a value of from 0.8 to 1.2.

33. A process as claimed in claim 15 wherein an aqueous or ethylene glycol reaction mixture is formed by combining reactive aluminium and phosphorous sources and thereafter combining the mixture with the organic template followed by a silicon source for SAPO-35 and SAPO-15 formation.

34. A process as claimed in claim 12 wherein the molecular sieve obtained is AlPO₄-5 having an X-ray diffraction pattern given in the table below:

| 2θ | d-spacing | Relative intensity |
|---|---|---|
| 7.68 | 11.5 | 49 |
| 13.16 | 6.72 | 8 |
| 15.16 | 5.84 | 18 |
| 20.08 | 4.42 | 47 |
| 21.02 | 4.22 | 54 |
| 22.68 | 3.92 | 100 |
| 26.32 | 3.38 | 39 |
| 29.18 | 3.06 | 22 |
| 30.44 | 2.93 | 27 |
| 35.00 | 2.56 | 23 |
| 37.74 | 2.38 | 23 |

35. A process as claimed in claim 12 wherein the molecular sieve obtained is AlPO4-16 having an X-ray diffraction pattern given below:

| 2θ | d-spacing | Relative intensity |
|---|---|---|
| 11.28 | 7.83 | 62 |
| 15.48 | 5.72 | 2 |
| 17.26 | 5.13 | 2 |
| 18.66 | 4.75 | 50 |
| 21.86 | 4.06 | 100 |
| 22.90 | 3.875 | 9 |
| 26.50 | 3.357 | 27 |
| 27.60 | 3.23 | 2 |
| 27.94 | 3.19 | 2 |
| 29.96 | 3.08 | 12 |
| 29.72 | 3.00 | 28 |
| 32.72 | 2.735 | 4 |
| 34.60 | 2.585 | 5 |
| 37.36 | 2.374 | 8 |
| 39.56 | 2.276 | 2 |
| 44.16 | 2.049 | 2 |
| 45.46 | 1.877 | 6 |
| 52.34 | 1.746 | 3 |
| 54.74 | 1.675 | 3 |

36. A process as claimed in claim 12 wherein the AlPO₄-22 obtained has a X-ray diffraction pattern given in the table below:

| 2θ | d-spacing | Relative intensity |
|---|---|---|
| 6.06 | 14.57 | 100 |
| 9.02 | 9.80 | 34 |
| 11.26 | 7.85 | 12 |
| 13.00 | 6.80 | 17 |
| 17.22 | 5.15 | 29 |
| 8.42 | 4.81 | 78 |
| 20.44 | 4.34 | 57 |
| 21.78 | 4.08 | 24 |
| 22.54 | 3.94 | 10 |
| 23.48 | 3.79 | 16 |
| 23.86 | 3.73 | 22 |
| 24.72 | 3.60 | 19 |
| 26.04 | 3.42 | 35 |
| 27.22 | 3.27 | 31 |
| 28.5 | 3.13 | 22 |
| 29.18 | 3.06 | 42 |
| 31.4 | 2.85 | 35 |
| 34.76 | 2.58 | 27 |
| 48.02 | 1.89 | 15 |
| 48.52 | 1.87 | 15 |

37. A process as claimed in claim 12 wherein the molecular sieve obtained is AlPO4-22 having an X-ray diffraction pattern given in the table below:

| 2θ | d-spacing | Relative intensity |
|---|---|---|
| 7.48 | 11.82 | 22 |
| 14.98 | 5.91 | 18 |
| 19.84 | 4.47 | 37 |
| 20.44 | 4.34 | 25 |
| 21.10 | 4.21 | 19 |
| 21.80 | 4.07 | 100 |
| 22.48 | 3.95 | 45 |
| 26.04 | 3.42 | 23 |
| 29.14 | 3.06 | 10 |
| 30.16 | 2.96 | 21 |
| 31.16 | 2.87 | 13 |
| 34.70 | 2.58 | 16 |
| 35.78 | 2.51 | 26 |
| 37.82 | 2.38 | 9 |

38. A process as claimed in claim 12 wherein the molecular sieve obtained is AlPO₄-L having an X-ray diffraction pattern given in the table below:

| 2θ | d-spacing | Relative intensity |
|---|---|---|
| 6.4 | 13.80 | 100 |
| 12.6 | 7.02 | 8 |
| 18.6 | 4.77 | 12.5 |

39. A process as claimed in claim 12 wherein the molecular sieve obtained is SAPO-35 having an X-ray diffraction pattern given in the table below

| 2θ | d-spacing | Relative intensity |
|---|---|---|
| 8.68 | 10.18 | 15 |
| 11.00 | 8.04 | 30 |
| 13.40 | 6.60 | 31 |
| 17.38 | 5.10 | 72 |
| 21.08 | 4.21 | 40 |
| 21.98 | 4.04 | 100 |
| 23.30 | 3.81 | 22 |
| 25.06 | 3.55 | 9 |
| 26.96 | 3.30 | 30 |
| 28.58 | 3.12 | 47 |
| 29.18 | 3.06 | 17 |
| 32.22 | 2.78 | 71 |
| 34.58 | 2.59 | 12 |
| 43.00 | 2.10 | 9 |

40. A process as claimed in claim 12 wherein the molecular sieve obtained is SAPO-15 having an X-ray diffraction pattern given in the table below:

| 2θ | d-spacing | Relative intensity |
|---|---|---|
| 11.98 | 7.38 | 45 |
| 13.48 | 7.56 | 77 |
| 15.16 | 5.84 | 100 |
| 19.3 | 4.60 | 50 |
| 21.04 | 4.22 | 17 |
| 21.50 | 4.13 | 34 |
| 24.06 | 3.70 | 33 |
| 25.6 | 3.48 | 12 |
| 26.98 | 3.30 | 15 |
| 29.78 | 3.00 | 57 |
| 30.50 | 2.93 | 50 |
| 31.80 | 2.81 | 44 |
| 32.28 | 2.77 | 60 |
| 34.46 | 2.61 | 61 |
| 35.94 | 2.50 | 15 |
| 36.90 | 2.43 | 14 |
| 37.82 | 2.38 | 13 |
| 38.94 | 2.31 | 38 |
| 39.90 | 2.26 | 11 |
| 40.78 | 2.21 | 12 |
| 42.24 | 2.14 | 15 |
| 43.28 | 2.09 | 16 |
| 44.02 | 2.06 | 10 |
| 46.16 | 1.96 | 23 |

41. A process as claimed in claim 12 wherein the molecular sieve obtained is VPI-5 having an X-ray diffraction pattern given in the table below:

| 2θ | d-spacing | Relative intensity |
|---|---|---|
| 5.24 | 16.85 | 60 |
| 6.80 | 12.99 | 11 |
| 10.68 | 8.28 | 25 |
| 14.22 | 6.22 | 25 |
| 18.62 | 4.76 | 21 |
| 20.36 | 4.36 | 11 |
| 21.12 | 4.20 | 31 |
| 21.70 | 4.09 | 100 |
| 22.38 | 3.97 | 83 |
| 23.50 | 3.78 | 41 |
| 24.3 | 3.66 | 22 |
| 25.96 | 3.43 | 12 |
| 27.08 | 3.29 | 68 |
| 28.12 | 3.17 | 38 |
| 28.82 | 3.10 | 35 |
| 29.32 | 3.04 | 18 |
| 30.16 | 2.96 | 34 |
| 32.62 | 2.74 | 34 |
| 38.18 | 2.36 | 41 |
| 49.14 | 1.85 | 27 |
